(19) United States
(12) Patent Application Publication
(10) Pub. No.: US 2023/0100440 A1
(43) Pub. Date: Mar. 30, 2023

(54) BATTERY PACK HOUSING

(71) Applicant: Apple Inc., Cupertino, CA (US)

(72) Inventors: Dylan Erb, San Jose, CA (US); Nivay Anandarajah, San Leandro, CA (US); Abraham B. Caulk, San Jose, CA (US); Alexander J. Clarabut, Santa Clara, CA (US); Yu-Hung Li, Sunnyvale, CA (US); Evan D. Maley, Redwood City, CA (US)

(21) Appl. No.: 17/448,756

(22) Filed: Sep. 24, 2021

(51) Int. Cl. H01M 10/6554; H01M 50/207; H01M 10/613; H01M 50/271; H01M 50/291

(52) U.S. Cl. CPC H01M 10/6554; H01M 50/207; H01M 10/613; H01M 50/271; H01M 50/291

(57) ABSTRACT

Battery packs according to some embodiments of the present technology may include a first end beam and a second end beam. The battery packs may include a first side beam and a second side beam each extending between the first end beam and the second end beam. The battery packs may include a base. The first end beam, the second end beam, the first side beam, the second side beam, and the base may be welded along each interface between each component. The battery packs may include a plurality of battery cells disposed between the first side beam and the second side beam. Each battery cell of the plurality of battery cells may be separated from an adjacent battery cell by an interface material. The battery packs may include a lid coupled with a surface of each battery cell of the plurality of battery cells facing the lid.

### TECHNICAL FIELD

The present technology relates to battery structures and systems. More specifically, the present technology relates to methods of configuring and producing batteries and battery pack housing.

### BACKGROUND

Battery placement within a battery pack may be performed with many considerations. For example, battery configurations with compact placement of battery cells may provide increased energy density by allowing more battery cells within the pack. There are many thermal, structural, and mechanical challenges with the compact placement of cells.

### SUMMARY

Battery packs according to some embodiments of the present technology may include a first end beam. The battery packs may include a second end beam. The battery packs may include a first side beam extending between the first end beam and the second end beam. The battery packs may include a second side beam extending between the first end beam and the second end beam. The battery packs may include a base. The first end beam, the second end beam, the first side beam, the second side beam, and the base may be welded along each interface between each component. The battery packs may include a plurality of battery cells disposed between the first side beam and the second side beam. Each battery cell of the plurality of battery cells may be separated from an adjacent battery cell by an interface material. The battery packs may include a lid coupled with a surface of each battery cell of the plurality of battery cells facing the lid.

The battery packs may include a longitudinal beam extending between the first end beam and the second end beam. The longitudinal beam may be disposed between the first side beam and the second side beam. The plurality of battery cells may include a first plurality of battery cells. The battery pack may include a second plurality of battery cells disposed between the second side beam and the longitudinal beam. Each battery cell of the second plurality of battery cells may be separated from an adjacent cell by an interface material. The longitudinal beam may be characterized by a first longitudinal surface and a second longitudinal surface opposite the first longitudinal surface. A surface of each battery cell of the first plurality of battery cells including battery terminals may face the first longitudinal surface of the longitudinal beam. A surface of each battery cell of the second plurality of battery cells including battery terminals may face the second longitudinal surface of the longitudinal beam.

Each battery cell of the plurality of battery cells may include a vent facing the first side beam. A first battery cell of the plurality of battery cells may have the vent defined in a surface of the first battery cell proximate a surface of the first battery cell facing the lid. A second battery cell of the plurality of battery cells adjacent the first battery cell may have the vent defined in a surface of the second battery cell proximate a surface of the second battery cell facing the base. A side beam adjacent the first battery cell and the second battery cell may define a first plenum and a second plenum. The first plenum may be aligned with the vent of the first battery cell. The second plenum may be aligned with the vent of the second battery cell. The base may be a heat exchanger. The base may define fluid channels extending between the first side beam and the second side beam. The first end beam and the second end beam may be welded to the base at a distance between the first end beam and the second end beam that is less than an uncompressed distance of the plurality of battery cells. The battery packs may include a spacer between the plurality of battery cells and one of the first end beam or the second end beam.

Some embodiments of the present technology may encompass battery packs. The packs may include a first end beam. The packs may include a second end beam. The packs may include a first side beam extending between the first end beam and the second end beam. The packs may include a second side beam extending between the first end beam and the second end beam. The packs may include a longitudinal beam extending between the first end beam and the second end beam. The longitudinal beam may be disposed between the first side beam and the second side beam. The packs may include a base. The first end beam, the second end beam, the first side beam, the second side beam, the longitudinal beam, and the base may be welded along each interface between each component. The packs may include a first plurality of battery cells disposed between the first side beam and the longitudinal beam. Each battery cell of the first plurality of battery cells may be separated from an adjacent cell by an interface material. The packs may include a second plurality of battery cells disposed between the second side beam and the longitudinal beam. Each battery cell of the second plurality of battery cells may be separated from an adjacent cell by an interface material. The packs may include a lid coupled with a surface of each battery cell of the first plurality of battery cells and the second plurality of battery cells.

In some embodiments, the longitudinal beam may be characterized by a first longitudinal surface and a second longitudinal surface opposite the first longitudinal surface. A surface of each battery cell of the first plurality of battery cells including battery terminals may face the first longitudinal surface of the longitudinal beam. A surface of each battery cell of the second plurality of battery cells including battery terminals may face the second longitudinal surface of the longitudinal beam. The base may be a heat exchanger. The base may define fluid channels extending orthogonally to the longitudinal beam. The first end beam and the second end beam may be welded to the base at a distance between the first end beam and the second end beam that is less than an uncompressed distance of the first plurality of battery cells or the second plurality of battery cells. The first end beam and the second end beam may maintain a force of greater than or about 5 kN on the first plurality of battery cells and the second plurality of battery cells.

Each battery cell of the first plurality of battery cells may include a vent in a surface of the battery cell adjacent the first side beam. Each battery cell of the second plurality of battery cells may include a vent in a surface of the battery cell adjacent the second side beam. A first battery cell of the first plurality of battery cells may have the vent defined in the surface proximate a surface of the first battery cell adjacent the lid. A second battery cell of the first plurality of battery cells adjacent the first battery cell may have the vent defined in the surface proximate a surface of the second battery cell adjacent the base. The first side beam adjacent the first plurality of battery cells may define a first plenum and a second plenum. The first plenum may be aligned with the vent of the first battery cell. The second plenum may be aligned with the vent of the second battery cell.

Some embodiments of the present technology may encompass battery packs. The battery packs may include a first end beam. The battery packs may include a second end beam. The battery packs may include a first side beam extending between the first end beam and the second end beam. The battery packs may include a second side beam extending between the first end beam and the second end beam. The battery packs may include a base. The first end beam, the second end beam, the first side beam, the second side beam, and the base may be welded together. The battery packs may include a plurality of battery cells disposed between the first side beam and the second side beam. each battery cell of the plurality of battery cells may be separated from an adjacent battery cell by an interface material. The first end beam and the second end beam may be welded to the base at a distance between the first end beam and the second end beam that is less than an uncompressed distance of the plurality of battery cells. In some embodiments, the base may be a heat exchanger. A side beam adjacent vents on the plurality of battery cells may define an exhaust plenum for the vents.

Such technology may provide numerous benefits over conventional technology. For example, the present systems may increase volumetric energy density over conventional pack structures. Additionally, the present systems may have improved component structural integrity by forming a welded housing structure that may apply a compressive force against the battery cells. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic exploded view of a battery pack according to some embodiments of the present technology.

FIG. 2 shows a schematic partial isometric view of battery pack housing components according to some embodiments of the present technology.

FIGS. 3A-3C show schematic cross-sectional views of processes incorporating battery cells between end beams according to some embodiments of the present technology.

FIG. 4 shows a schematic isometric view of a base member of a battery pack according to some embodiments of the present technology.

FIG. 5 shows a schematic partial cross-sectional view of a base member of a battery pack according to some embodiments of the present technology.

FIG. 6 shows a schematic partial sectional view through a side beam of a battery pack according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Battery packs may include any number of battery cells packaged together to produce an amount of power. For example, many rechargeable batteries may include multiple cells having any number of designs including wound, stacked, prismatic, as well as other configurations. The individual cells may be coupled together in a variety of ways including series connections and parallel connections. As increased capacity is sought from smaller form factors, battery cell configurations and packaging may play an important role in operation of the battery system under normal operating conditions as well as during abuse conditions.

For example, cell damage may lead to short circuiting in some battery cell designs, which may cause temperature increases initiating exothermic reactions leading to thermal runaway. These events may generate temperatures of several hundred degrees over a period of time that may be seconds, minutes, or more depending on the size and capacity of the cell. Thermal runaway may occur when internal temperatures within a battery cell exceed a threshold temperature whether damage has occurred within the cell or not. Regardless of the initiation mechanism, once begun, the result is often continuous heat generation until reactions have consumed the cell material. When battery cells are placed within a pack design, adjacent cells may be exposed to high temperatures from neighboring cells undergoing failure events. Should this exposure occur over a sufficient time period, the internal temperature within the adjacent cell may exceed the threshold for thermal runaway, extending the failure to the adjacent cell. This process may then continue across each cell within the pack eventually consuming the majority of cells, if not every cell.

Conventional packs have attempted to control failure spread of this nature by isolating cells, incorporating extensive insulation, or increasing the separation of cells from one another. Although this may provide additional protection from cell failure spreading to adjacent cells, this may also limit capacity of a battery pack below some system requirements. Additionally, when battery packs are used in devices that may be dropped, impacted, pierced, or otherwise damaged, the battery pack and constituent cells may also be damaged, which may cause similar exothermic reactions to occur. Consequently, conventional technologies may further insulate and isolate the battery cells from a housing or structural support, which may further reduce capacity or energy density of the battery pack. Additionally, many conventional pack designs may utilize modules containing a number of cells, and which may be positioned within a battery pack housing. These modules may be formed to apply a force to compress the battery cells, which may help maintain lamination of cell components as well as performance over time by limiting cell swelling. However, these modules may consume significant space within a battery pack, which may increase the weight of the pack, as well as reduce the volumetric energy density of the produced battery pack.

The present technology overcomes these issues by creating systems that incorporate the battery cells within the structure to facilitate load distribution for many different abuse events. By incorporating the battery cells directly with the overall pack structural supports, housing and enclosure components may be reduced, which may allow increased volumetric density and specific energy for the battery pack, which may provide a more compact and robust design compared to conventional systems. Advantageously, by incorporating components in a space efficient manner, the present technology may utilize less insulation due to the inherent heat spreading of coupling the cells directly to the enclosure. The present technology may also produce structurally superior housing with improved sealing compared to previous designs, and which may be used to apply the compressive force to batteries without the need for modules.

Although the remaining portions of the description will routinely reference lithium-ion or other rechargeable batteries, it will be readily understood by the skilled artisan that the technology is not so limited. The present techniques may be employed with any number of battery or energy storage devices, including other rechargeable and primary, or non-rechargeable, battery types, as well as electrochemical capacitors also known as supercapacitors or ultracapacitors. Moreover, the present technology may be applicable to batteries and energy storage devices used in any number of technologies that may include, without limitation, phones and mobile devices, handheld electronic devices, laptops and other computers, appliances, heavy machinery, transportation equipment including automobiles, water-faring vessels, air-travel equipment, and space-travel equipment, as well as any other device that may use batteries or benefit from the discussed designs. Accordingly, the disclosure and claims are not to be considered limited to any particular example discussed, but can be utilized broadly with any number of devices that may exhibit some or all of the electrical or other characteristics of the discussed examples.

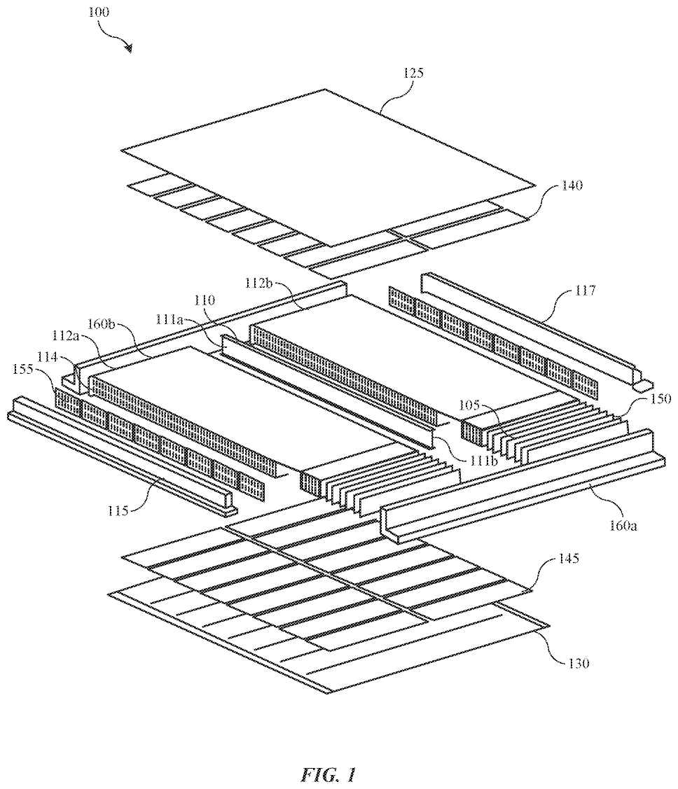

FIG. 1 shows a schematic exploded view of a battery pack 100 according to some embodiments of the present technology. Battery pack 100 includes a number of battery cells 105 distributed in rows along either side of a longitudinal beam 110. The battery cells 105 may be separated from one another by longitudinal beam 110 into two rows extending the length of the battery pack. In some embodiments a number of longitudinal beams may be included within the battery pack where additional structural support or larger form factors are produced. The longitudinal beams may provide structural integrity to the battery pack and may provide protection for battery terminals and battery coupling. As illustrated, battery pack 100 includes two sets of battery cells 105, including a first set 112a of battery cells 105, and a second set 112b of battery cells 105.

As shown, first set 112a of the battery cells may extend outward from a first longitudinal surface 111a of the longitudinal beam 110, and second set 112b of the battery cells may extend outward from a second longitudinal surface 111b of the longitudinal beam 110, which may be opposite the first longitudinal surface. The battery cells 105 may be reversed in orientation between the two sets, which may orient the battery terminals for all cells to be facing the longitudinal beam 110. For example, with respect to the second set 112b, the individual cells may be oriented so that the battery terminals 113 of each battery cell may be facing longitudinal beam 110, such as along second surface 111b. The same type of orientation may be provided with the first set of battery cells 112a, where the terminals may all face the first surface 111a of longitudinal beam 110. The battery cells may also be formed so that each cell may have a vent 114 on an opposite side of the cell from the terminals, and which may face an associated side beam as discussed further below.

Along surfaces of the battery cells opposite surfaces facing the longitudinal beam may be side beams. For example, a first side beam 115 may be positioned adjacent each battery cell of the first set 112a of the battery cells, and a second side beam 117 may be positioned adjacent each battery cell of the second set 112b of the battery cells. A lid 125 may be coupled overlying the battery cells, which may be seated on a base 130. In some embodiments, lid 125 may act as a structural member providing structural attachments to a system in which the battery pack is incorporated. As will be described further below, adjacent battery cells may alternate vertical location of the vent. For example, a first battery cell may include a vent 114 formed within a surface of the battery cell facing the side beam 115, with the vent formed proximate a top surface of the battery cell, such as facing the lid, and which may be in line with a first plenum formed in the side beam. Additionally, an adjacent battery cell may include a vent formed within a surface of the battery cell facing the side beam 115, with the vent formed proximate a bottom surface of the battery cell, such as facing the base, and which may be in line with a second plenum formed in the side beam. By alternating vent locations between adjacent batteries, a lower heat impact may be provided to adjacent battery cells during a particular abuse event. As will be shown below, the first plenum and the second plenum may be fluidly isolated from one another by a cross-member in the side beam as illustrated, which may further limit impact if two adjacent batteries exhaust heated effluent materials by separating the materials from one another within the side beam.

As illustrated, battery packs according to some embodiments of the present technology may not include additional housing separating the battery cells from the structural supports of the battery packs, although one or more spacers may be included as discussed further below. Many conventional battery packs may isolate the battery cells in modules that then may be incorporated within a structural setup for the battery pack. Because such modules may be characterized by specific geometries, the resulting battery packs may inefficiently utilize space, and may maintain a number of gaps about the structural members. The present technology may utilize alternative battery geometries and materials, which may be utilized directly with the pack structure to provide further reinforcement of the overall battery pack, as well as for the system in which the battery pack may be incorporated. For example, although battery cells encompassed by the present technology may be characterized by any dimensions, battery cells according to some embodiments of the present technology may be characterized by lateral dimensions, such as extending orthogonally to a length of longitudinal beam 110, of greater than or about 10 cm, and may be characterized by lateral dimensions greater than or about 20 cm, greater than or about 30 cm, greater than or about 40 cm, greater than or about 50 cm, greater than or about 60 cm, greater than or about 70 cm, greater than or about 80 cm, greater than or about 90 cm, greater than or about 100 cm, or more. Accordingly, each battery cell may extend from the longitudinal beam 110 to an associated side beam.

In many conventional designs, insulation may be provided along all sides of each cell or module to assist in controlling heat dissipation to adjacent cells. However, because of the rapid generation of heat during failure events, the heat transferred to adjacent cells may still be sufficient to raise internal temperatures of the adjacent cells above the threshold to initiate thermal runaway in the adjacent cells as well. Because of the insulation extending around the cells, the distribution of heat to the immediately adjacent cells may be substantially uniform, and the amount of heat generated in thermal runaway may cause internal temperatures of each adjacent cell to increase above the thermal runaway threshold. Consequently, many conventional designs may be limited to less compact configurations incorporating additional and thicker insulation and module designs that incorporate more battery cell separation.

The present technology may utilize battery cells in some embodiments that may be characterized by a slower reaction during failure events, or by a lower rate of degeneration of the cell materials. For example, during a failure event, reactions consuming active materials within the cell may be controlled based on the chemical makeup of the cells to slow the reaction, which may reduce the temperature of an event. Consequently, a peak temperature during failure may be maintained below or about 1,000° C., and may be maintained below or about 900° C., below or about 800° C., below or about 700° C., below or about 600° C., below or about 500° C., below or about 400° C., or lower. This may limit impact on adjacent cells, which may otherwise be unable to survive higher temperatures that may cause thermal runaway of adjacent batteries. Accordingly, batteries may be spaced closer together, or with less insulation between adjacent batteries in some embodiments of the present technology.

By disposing the battery cells against the surrounding structural components, heat transfer from the battery cells may be further improved and less insulation may be incorporated within the pack, which may further improve volumetric energy density. For example, in some embodiments lid 125 may be coupled with a first surface of each battery cell 105 utilizing a thermal interface material 140 and/or adhesive. Thermal interface material 140 may directly contact each battery cell 105 of both sets or all sets, and may contact lid 125 on an opposite surface. Similarly, in some embodiments base 130 may be coupled with a second surface of each battery cell 105 opposite the first surface. The base 130 may be coupled with the battery cells using a thermal interface material 145 and/or adhesive. Again, thermal interface material 145 may directly contact each battery cell 105 of the battery pack, and may contact base 130 on an opposite surface. As will be described below, base 130 may be or include a heat exchanger, and thus more direct contact between the battery cells and the base may further facilitate heat transfer from battery cells during operation.

A compliant pad 150 may be positioned between each battery cell and adjacent battery cells, in some embodiments of the present technology, although thermally conductive adhesives may also be used between some cells. For example, in some embodiments some adjacent cells may include a compliant pad disposed between them, and some adjacent cells may include a thermal interface material disposed between them. The materials may be included in any combination with each other, such as more of one or the other, where one material may be included every other cell, every third cell, every fourth cell, or further distributed, while the other component is included between each other cell pair. As battery cells are cycled during their life, the cells may swell over time as well as during normal operation as the cell heats. When cells are rigidly compressed or contained within a particular structure, the cells may have reduced cycle life. The present technology, however, may include compliant pads or insulation configured to provide an amount of deflection or compression to accommodate swelling of battery cells over time, as well as to reduce or limit heat transfer between adjacent cell blocks. The compliant pads 150 may be configured to fully occupy space between each battery cell to limit any gaps within the structure. However, the compliant pads may be configured to accommodate compression of up to or about 50% or more of its thickness to accommodate battery swelling over time. Unlike conventional technology that may not provide such accommodation, the present technology may produce longer battery life cycles based on the incorporated accommodation of battery swelling within each cell block, and may accommodate cell thickness tolerance. Additionally, the compliant material or materials may facilitate cell incorporation in sealed housing structures as will be described further below.

Between each side beam and the battery cells, a sealing foam 155 or pad may be incorporated, which may ensure complete seating of the side beam and the battery cells, and limit or prevent any gaps between the components. The housing may also include an end beam, which may be coupled against the battery cells at longitudinal ends of the battery pack to complete the pack structure. As illustrated, the end beams 160 may be formed fully between side beams, where the longitudinal beam may be coupled against an interior surface of the end beams. This may allow a battery set to be disposed in a partially constructed housing as described further below, which may increase sealing capabilities of the housing, and an ability to apply a compressive force against the battery cells.

The compliant pads 150 and/or sealing foam 155 may be intended to reduce heat transfer, and may be characterized by a thermal conductivity of less than or about 0.5 W/m·K, and may be characterized by a thermal conductivity of less than or about 0.4 W/m·K, less than or about 0.3 W/m·K, less than or about 0.2 W/m·K, less than or about 0.1 W/m·K, less than or about 0.05 W/m·K, or less. The pads may be or include any number of insulative materials, and may include thermally resistive blankets, mats, and other materials that may include oxides of various metals, as well as other insulative materials that may contribute to any of the thermal conductivity numbers stated. Because of the distribution of heat away from adjacent cells, the present technology may facilitate a reduction in insulation between cells. For example, in some embodiments the amount of insulation provided between each battery cell may be less than or about 2 cm in thickness, and may be less than or about 1 cm, less than or about 8 mm, less than or about 6 mm, less than or about 5 mm, less than or about 4 mm, less than or about 3 mm, less than or about 2 mm, or less in some embodiments. The reduced insulation may contribute additional volume in a battery pack, which may be used to incorporate additional or larger battery cells, increasing overall capacity.

The thermal interface material 140 and/or thermal interface material 145 may be intended to increase heat transfer, and may be characterized by a thermal conductivity of greater than or about 0.5 W/m·K, and may be characterized by a thermal conductivity of greater than or about 1 W/m·K, greater than or about 2 W/m·K, greater than or about 5 W/m·K, greater than or about 10 W/m·K, greater than or about 25 W/m·K, or greater. The thermal interface materials may be or include any number of thermally conductive materials, and may include thermal pastes or grease, polymeric, or other conductive materials. In some embodiments the thermal interface material may not be electrically conductive, for example. In some embodiments because the surface of the cell block may not be electrically charged, an electrically conductive paste, which may also increase thermal conductivity, may be used. Additionally, material 140 and/or material 145 may be a structural adhesive in addition to or as an alternative to a thermally conductive adhesive. This may increase overall packaging efficiency within the pack. By utilizing the thermal interface materials to facilitate heat transfer away from the battery cells of the battery pack, the amount of insulation utilized may be reduced as battery cell temperature may be maintained at lower temperatures, and which again may increase the useable space within a battery pack for battery cells.

The longitudinal beams, side beams, end beams, as well as the lid and/or base, may be made of any number of materials, and may act as structural members of the battery pack 100. Accordingly, the materials may be or include aluminum, steel, plastic materials, or composite materials providing some balance between strength, rigidity, and flexibility. The longitudinal beams and lateral walls may also provide an amount of heat conduction away from battery cell blocks that are in fault or other abuse conditions, including thermal runaway. The longitudinal beam may be an I-beam in some embodiments of the present technology. While this may create recessed space along the length of the beams, this space may be used to accommodate aspects of the present technology. For example, as noted above, the recessed space may accommodate busbar and other connection materials that couple with the battery terminals.

Battery pack housing in many configurations may be coupled in any number of ways, including adhesives, bonding, mechanical joining, or some combination. While cylindrical battery cells, and many primary batteries, may constitute a pressure vessel that can accommodate cell expansion, prismatic batteries often have an amount of counter pressure applied against them to limit swelling and maintain component lamination. Accordingly, when housing components are utilized to exert this pressure, the housing components are typically joined one component at a time, and used to apply pressure. This proximity to the battery cells themselves may limit the types of joining available. For example, welding may not be utilized due to heat or energy dissipation proximate the battery cell walls, which may cause damage. Even with more conventional modules used in packaging, the housing may be produced without welding to limit the possibility of cell damage, which can be even more detrimental in modular packaging as it can lead to scrapping an entire module due to damage of a single cell. However, adhesive and mechanical joining of components may cause multiple issues, including lack of hermetic sealing of the housing, and joint integrity. While mechanical joining may improve joint integrity, sealing is more difficult. Similarly, while adhesives may improve sealing, when vertical and horizontal seals intersect, integrity may be limited as the formation of one seal may cause damage or loss of strength to an adjacent seal.

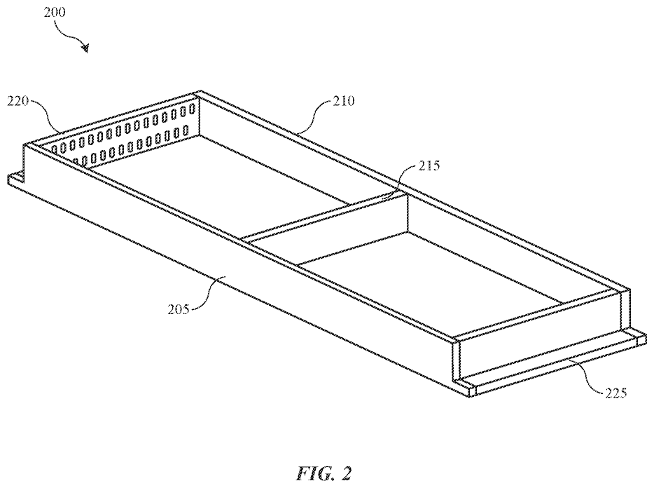

The present technology overcomes these issues by joining the majority of the housing components prior to installation of the battery cells. While this may occur with modular housings, the structure is necessarily less volume efficient, as the modules cannot be compressed, and thus the battery pack must maintain gaps sufficient to overcome any tolerance issues. The present technology, however, may utilize packaging processes to allow the battery cells to be seated within a housing that has been fabricated to apply a compressive force against the batteries. FIG. 2 shows a schematic partial isometric view of components of battery pack housing 200 according to some embodiments of the present technology, where some of the housing components may be pre-joined prior to installation of the battery cells, including components intended to apply a compressive pressure to the cells. For example, the two end beams may apply a compressive force against the battery cells, and in some embodiments, these components may already be joined with the base and/or other components prior to disposing the battery cells within the housing.

As illustrated, battery pack housing 200 may include components discussed above, such as a first end beam 205, a second end beam 210, a longitudinal beam 215, a first side beam 220, and a second side beam 225. Any number of additional side and/or longitudinal beams may be included to allow the incorporation of additional battery cell sets as discussed above. Any of these components may include any of the features, components, materials, or characteristics of any of the components discussed above. In some embodiments, each of these components may be joined with any other of these components to produce a housing substrate. Additionally, by forming the housing, such as every component but the lid, or every component but the base, prior to installing the battery cells, improved structural integrity may be afforded by allowing any type of joining to be performed. For example, on one or more interfaces, including along every interface between the components, the components may be welded or bonded. Although adhesives and/or mechanical joining, such as bolts, screws, or any other type of fastener, may be performed on one or more interfaces including in addition to welding or bonding, in some embodiments, adhesives and/or mechanical joining may not be included to couple any interface, including vertical interfaces, such as between the longitudinal beam and end beams or between the end beams and the side beams, as well as any horizontal interface, such as any interface with the base. This may allow more structural resiliency to be provided, and may ensure hermetic sealing between the components. Because the lid, or base in other embodiments, may be applied subsequent to incorporating the battery cells, the lid may be adhered and/or mechanically coupled with the other housing components, which may protect the battery cells from welding or other heat or arc-based coupling.

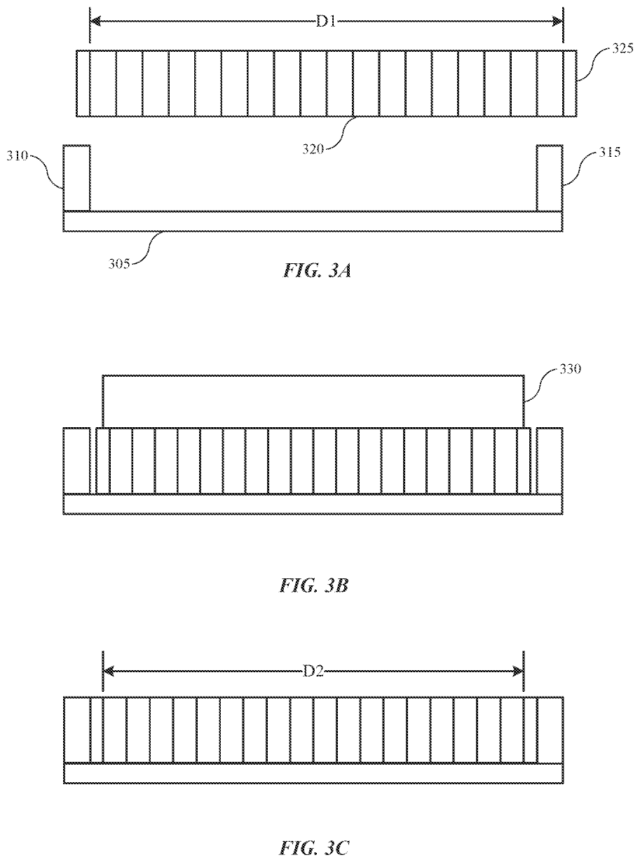

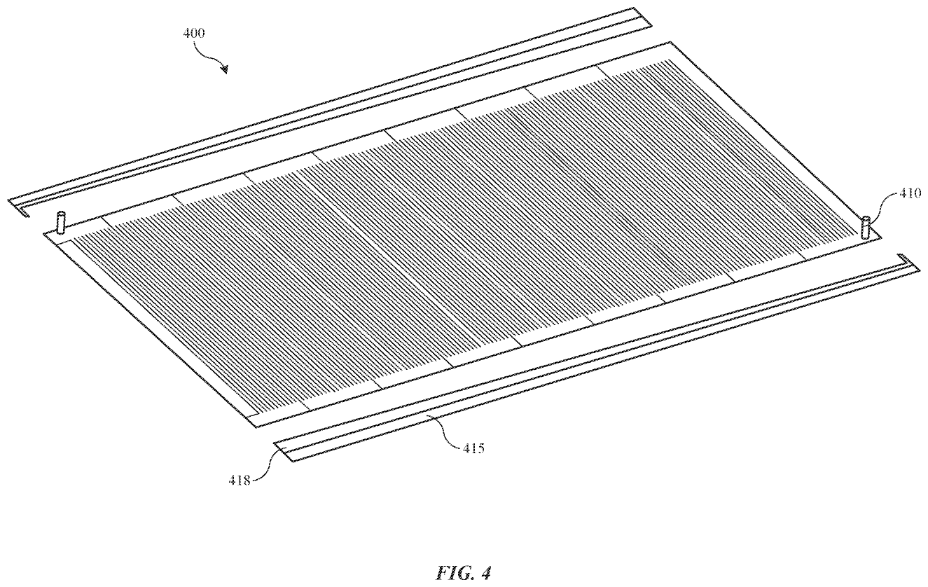

Because the housing may be used to apply a compressive force to the battery cells in some embodiments of the present technology, the housing components may be spaced to ensure a compressive force may be applied. FIGS. 3A-3C show schematic cross-sectional views of processes incorporating battery cells between end beams according to some embodiments of the present technology. For example, as illustrated in FIG. 3A, a housing structure may include a base 305, a first end beam 310, and a second end beam 315, which may include any component, feature, or characteristic of components described previously. As explained above, these components may be welded together prior to installation of a set of battery cells, and the first end beam 310 and the second end beam 315 may be spaced across the base at a distance configured to apply a compressive force against the battery cells, and which may be a distance less than an uncompressed distance of the battery cells. For example, as illustrated, a plurality of battery cells 320, which may be a set of battery cells as described above, may be characterized by a length of the battery cells to be incorporated in a direction between the first end beam and the second end beam, which may be greater than the distance between the welded first end beam and second end beam on the base, and may constitute an uncompressed distance D1 of the formed and packaged battery cells. It is to be understood that battery cells may also include intervening materials, such as compliant pads and/or thermal interface materials as discussed above. Accordingly, in some embodiments, the battery pack may be compressed in order to be disposed within the battery pack housing.

For example, in some embodiments, a spacer 325 may be included with the set of battery cells discussed above, and may include a first spacer at a first end of the plurality of battery cells, and a second spacer at a second end of the plurality of battery cells. These spacers may be included along the width of the battery cells, such as facing the end beams, where the terminals and vents on each battery cell may be positioned facing the side beams and/or longitudinal beam. This may allow a force to be applied to compress the battery cells for inclusion in the housing. In some embodiments, the spacers may be included to allow a more uniform compression to be applied across the face of the battery cells to limit the possibility of buckling or indentation, although depending on the battery cell packaging, which may be polymer sleeves or cases, the packaging may accommodate the forces applied. Although D1 is illustrated as being characterized by a uncompressed length of the battery cells 320 exclusive of the spacers 325, it is to be understood that in some embodiments D1 may include one or both spacers in encompassed embodiments.

As shown in FIG. 3B, in some embodiments, the plurality of battery cells may be compressed to a distance less than a distance between the first end beam and the second end beam. Any number or variation of an apparatus 330 may be used to compress the battery cells. For example, in some embodiments the spacers 325 may include apertures or throughways allowing fingers or extensions to be inserted through the apertures to extend fully along a height of the battery cells. One or both sides of the apparatus may be actuated, such as at a set force, to drive one or both spacers towards each other, which may compress the battery stack. In some embodiments, the apparatus may be a belt tensioner, and one or more belts or bands may be fitted about the battery cells, and a number of bands may be used in some embodiments. This may allow thinner spacers or no spacers to be included, for example, which may further increase the amount of internal volume occupied by the battery cells. The tensioner may draw on the bands, and compress the battery cells. Any number of apparatuses that drive or pull the battery cells together may be used in embodiments of the present technology. The stack of battery cells may then be disposed in the housing, such as between the first end beam and the second end beam.

As illustrated in FIG. 3C, the apparatus may be removed, and the cells may expand to fill the distance between the first end beam and the second end beam. This expanded length D2 may be a length of battery cells, which may still be compressed a certain amount. Accordingly, D2 may be a length less than or about a length of D1, and again may or may not include the spacers in encompassed embodiments. A difference between D1 and D2 may be any length, which may depend on the length and number of battery cells, for example, and the difference may be greater than or about 1 mm, greater than or about 2 mm, greater than or about 3 mm, greater than or about 4 mm, greater than or about 5 mm, greater than or about 6 mm, greater than or about 7 mm, greater than or about 8 mm, greater than or about 9 mm, greater than or about 10 mm, greater than or about 20 mm, greater than or about 50 mm, or more. For example, a plug or bolt may be applied through an end beam to maintain pressure on the battery cell stack while the apparatus is removed. The plug or bolt may be removed to allow the expansion, and the access may be sealed. However, the cell stack and/or spacers may not fully expand to the distance prior to insertion in the housing, and an amount of compressive force may be applied to maintain the cells in a partially compressed state. For example, in some embodiments, once expanded as illustrated in the figure, the battery cells may still be partially compressed at a force applied by the first end beam and the second end beam that is greater than or about 1 kN, and may be greater than or about 2 kN, greater than or about 5 kN, greater than or about 10 kN, greater than or about 15 kN, greater than or about 20 kN, greater than or about 25 kN, greater than or about 30 kN, or more. Because the end beams may be welded to the base due to the joining occurring prior to exposure of the battery cells, increased strength may be afforded, and thus, increased force that may be applied to the battery cells, without requiring additional components within the housing that may reduce volumetric energy density, such as module housing, for example.

FIG. 4 shows a schematic isometric view of a base member 400 that may be used in battery packs according to some embodiments of the present technology. Base member 400 may be included with battery packs described elsewhere in the present disclosure, and may illustrate additional features of base members according to some embodiments of the present technology. Base member 400 may include one or more sections that may be bonded, welded, or otherwise coupled together to form the base member. Each section may be extruded or otherwise formed to provide fluid channels extending across the base member. Each channel may be fluidly isolated within the base to control fluid flow within the base, and maintain a heat transfer fluid isolated from the battery cells. Base member 400 may operate as both a heat exchanger as well as an external support and protective member for the battery pack based on the materials and configuration. By combining these features into a single component, further space savings may be provided.

As illustrated, base member 400 may include inlet/outlet ports 410 for delivering and retrieving the heat transfer fluid from the base member 400. A manifold 415, removed from the base member for ease of viewing, may define a channel 418 extending along the manifold, and which may deliver the heat transfer fluid along a length of the base member. As illustrated, the manifold channel 418 may increase in volume or width along the length, and the opposite manifold may have a reverse channel formed. These channels may cooperate to produce a more equal conductance of heat transfer fluid at each fluid channel through the base member along a longitude of the base member, which may facilitate more uniform heat transfer from each battery cell of the battery pack.

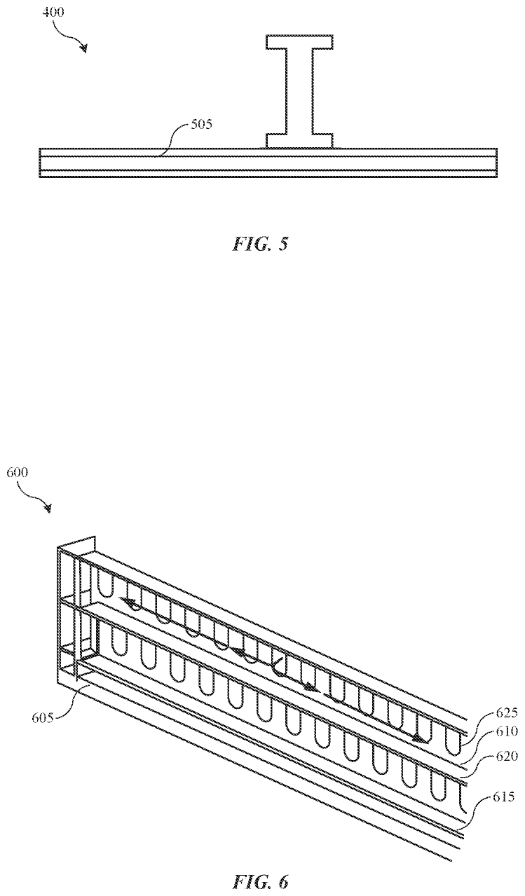

FIG. 5 shows a schematic partial cross-sectional view of base member 400 for use in a battery pack according to some embodiments of the present technology, and may illustrate additional features of base member 400 and fluid channels extending through the base member. As illustrated, fluid channels 505 may be formed within the base member. In some embodiments the fluid channels 505 may be formed integrally with the base member sections, which may be extruded metal. Accordingly, the channels may each be fluidly isolated from each other and from the battery cells that may be seated on the base member, or coupled with the base member with a thermal interface material. This formation of isolated channels may also increase a pressure threshold that the heat exchanger may withstand. Consequently, in some embodiments heat transfer fluids that may be used in the system may include aqueous fluids, such as may include glycol or other materials, as well as refrigerant that may be maintained under pressure within the base member and an associated refrigerant loop.

FIG. 6 shows a schematic partial sectional view through a side beam of a battery pack 600 according to some embodiments of the present technology, and may illustrate a cross-section extending longitudinally across a portion of the battery pack, such as along a side beam. Battery pack 600 may include any feature, component, or characteristic of battery packs described previously, and may illustrate additional features of any battery pack described elsewhere, or other battery packs encompassed by the present technology. Battery pack 600 may illustrate additional features of a plenum structure formed within the side beams according to some embodiments. For example, side beam 605 may define a first plenum 610 and a second plenum 615, which may be fluidly separated along the side beam with a divider 620. The plenums may be formed adjacent vents of the battery cells. As noted previously, each battery cell may have the vent formed at an alternating location along a corresponding surface from adjacent battery cells. For example, while a first battery cell includes a vent near the lid, which may exhaust into the first plenum 610, an adjacent battery cell may include a vent near the base, which may exhaust into the second plenum 615. These separate venting plenums may limit interaction of effluent materials with adjacent batteries. The plenums may extend to a pack vent located at an end beam or integrated into a side beam, which may allow any effluent materials to leave the battery pack. By utilizing structural components and configurations according to embodiments of the present technology, battery packs may be produced having improved structural integrity, while limiting increases in volume due to additional packaging and insulation materials.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery pack comprising:
a first end beam;
a second end beam;
a first side beam extending between the first end beam and the second end beam;
a second side beam extending between the first end beam and the second end beam;
a base, wherein the first end beam, the second end beam, the first side beam, the second side beam, and the base are welded along each interface between each component;
a plurality of battery cells disposed between the first side beam and the second side beam, wherein each battery cell of the plurality of battery cells is separated from an adjacent battery cell by an interface material; and
a lid coupled with a surface of each battery cell of the plurality of battery cells facing the lid.

2. The battery pack of claim 1, further comprising:
a longitudinal beam extending between the first end beam and the second end beam, wherein the longitudinal beam is disposed between the first side beam and the second side beam.

3. The battery pack of claim 2, wherein the plurality of battery cells comprise a first plurality of battery cells, and wherein the battery pack further comprises:
a second plurality of battery cells disposed between the second side beam and the longitudinal beam, wherein each battery cell of the second plurality of battery cells is separated from an adjacent cell by an interface material.

4. The battery pack of claim 3, wherein the longitudinal beam is characterized by a first longitudinal surface and a second longitudinal surface opposite the first longitudinal surface, wherein a surface of each battery cell of the first plurality of battery cells including battery terminals faces the first longitudinal surface of the longitudinal beam, and wherein a surface of each battery cell of the second plurality of battery cells including battery terminals faces the second longitudinal surface of the longitudinal beam.

5. The battery pack of claim 1, wherein each battery cell of the plurality of battery cells comprises a vent facing the first side beam.

6. The battery pack of claim 5, wherein a first battery cell of the plurality of battery cells has the vent defined in a surface of the first battery cell proximate a surface of the first battery cell facing the lid, and wherein a second battery cell of the plurality of battery cells adjacent the first battery cell has the vent defined in a surface of the second battery cell proximate a surface of the second battery cell facing the base.

7. The battery pack of claim 6, wherein a side beam adjacent the first battery cell and the second battery cell defines a first plenum and a second plenum, wherein the first plenum is aligned with the vent of the first battery cell, and wherein the second plenum is aligned with the vent of the second battery cell.

8. The battery pack of claim 1, wherein the base is a heat exchanger, and wherein the base defines fluid channels extending between the first side beam and the second side beam.

9. The battery pack of claim 1, wherein the first end beam and the second end beam are welded to the base at a distance between the first end beam and the second end beam that is less than an uncompressed distance of the plurality of battery cells.

10. The battery pack of claim 1, further comprising:
a spacer between the plurality of battery cells and one of the first end beam or the second end beam.

11. A battery pack comprising:
a first end beam;
a second end beam;
a first side beam extending between the first end beam and the second end beam;
a second side beam extending between the first end beam and the second end beam;
a longitudinal beam extending between the first end beam and the second end beam, wherein the longitudinal beam is disposed between the first side beam and the second side beam;
a base, wherein the first end beam, the second end beam, the first side beam, the second side beam, the longitudinal beam, and the base are welded along each interface between each component;
a first plurality of battery cells disposed between the first side beam and the longitudinal beam, wherein each battery cell of the first plurality of battery cells is separated from an adjacent cell by an interface material;
a second plurality of battery cells disposed between the second side beam and the longitudinal beam, wherein each battery cell of the second plurality of battery cells is separated from an adjacent cell by an interface material; and
a lid coupled with a surface of each battery cell of the first plurality of battery cells and the second plurality of battery cells.

12. The battery pack of claim 11, wherein the longitudinal beam is characterized by a first longitudinal surface and a second longitudinal surface opposite the first longitudinal surface, wherein a surface of each battery cell of the first plurality of battery cells including battery terminals faces the first longitudinal surface of the longitudinal beam, and wherein a surface of each battery cell of the second plurality of battery cells including battery terminals faces the second longitudinal surface of the longitudinal beam.

13. The battery pack of claim 11, wherein the base is a heat exchanger, and wherein the base defines fluid channels extending orthogonally to the longitudinal beam.

14. The battery pack of claim 11, wherein the first end beam and the second end beam are welded to the base at a distance between the first end beam and the second end beam that is less than an uncompressed distance of the first plurality of battery cells or the second plurality of battery cells.

15. The battery pack of claim 14, wherein the first end beam and the second end beam maintain a force of greater than or about 5 kN on the first plurality of battery cells and the second plurality of battery cells.

16. The battery pack of claim 11, wherein each battery cell of the first plurality of battery cells comprises a vent in a surface of the battery cell adjacent the first side beam, and wherein each battery cell of the second plurality of battery cells comprises a vent in a surface of the battery cell adjacent the second side beam.

17. The battery pack of claim 16, wherein a first battery cell of the first plurality of battery cells has the vent defined in the surface proximate a surface of the first battery cell adjacent the lid, and wherein a second battery cell of the first plurality of battery cells adjacent the first battery cell has the vent defined in the surface proximate a surface of the second battery cell adjacent the base.

18. The battery pack of claim 17, wherein the first side beam adjacent the first plurality of battery cells defines a first plenum and a second plenum, wherein the first plenum is aligned with the vent of the first battery cell, and wherein the second plenum is aligned with the vent of the second battery cell.

19. A battery pack comprising:
a first end beam;
a second end beam;
a first side beam extending between the first end beam and the second end beam;
a second side beam extending between the first end beam and the second end beam;
a base, wherein the first end beam, the second end beam, the first side beam, the second side beam, and the base are welded together; and
a plurality of battery cells disposed between the first side beam and the second side beam, wherein each battery cell of the plurality of battery cells is separated from an adjacent battery cell by an interface material, and wherein the first end beam and the second end beam are welded to the base at a distance between the first end beam and the second end beam that is less than an uncompressed distance of the plurality of battery cells.

20. The battery pack of claim 19, wherein the base is a heat exchanger, and wherein a side beam adjacent vents on the plurality of battery cells defines an exhaust plenum for the vents.
